(19) United States
(12) Patent Application Publication
(10) Pub. No.: US 2019/0195296 A1
(43) Pub. Date: Jun. 27, 2019

(54) BICYCLE HUB APPARATUS

(71) Applicant: CHING-SHU CHEN, CHANGHUA (TW)

(72) Inventor: CHING-SHU CHEN, CHANGHUA (TW)

(73) Assignee: CHOSEN CO., LTD., CHANGHUA CITY (TW)

(21) Appl. No.: 15/854,708

(22) Filed: Dec. 26, 2017

(51) Int. Cl. F16D 41/28; F16D 41/07

(52) U.S. Cl. CPC F16D 41/28; F16D 2300/06; F16D 41/07

(57) ABSTRACT

A bicycle hub apparatus may comprise a wheel hub, a hub body for installing a sprocket, and a one-way bearing unit positioned between the wheel hub and the hub body. A connecting housing is formed at a lateral end of the wheel hub, and a shaft axially protrudes from a central portion of the connecting housing. A driving ring made of high-strength material is securely positioned in the connecting housing, and a driving surface is formed on an inner periphery of the driving ring. The hub body adapted to connect to the wheel hub comprises a gear sleeve and a driving sleeve which are made of high-strength material to make the bicycle hub apparatus lightweight and prevent the wheel hub and the hub body from worn by the bearing unit, thereby improving transmission efficiency.

### FIELD OF THE INVENTION

The present invention relates to a bicycle hub apparatus and more particularly to a soundless bicycle hub apparatus.

### BACKGROUND OF THE INVENTION

Generally, a bicycle hub apparatus is configured to be driven in only forward direction to prevent reverse-rotated wheels from driving the pedals, leading to dangers. Also, in order to make a bike to be ridden smoothly, a conventional bicycle hub apparatus generally comprises a wheel hub and a hub body for sprocket, and a one-direction bearing is installed between the wheel hub and the hub body. Moreover, the forward-rotated hub body is configured to engage with the bearing and drive the wheel hub, thereby enable the bike to move forwardly. On the contrary, the backward-rotated hub body is adapted to not drive the wheel hub, and the hub body and the wheel hub are configured to rotate independently, thereby enabling the bike to keep coasting. Also, to meet current market demand, the wheel hub and the hub body are usually made of aluminum alloy.

However, the conventional bicycle hub apparatus is disadvantageous because: (i) the aluminum alloy is soft and easy to be deformed when applied force such that the wheel hub and the hub body are prone to be worn by the bearing and need to be changed more often, thereby increasing the costs; and (ii) generally, the wheel hub and the hub body are made integrally, and the lengthy hub apparatus increases the difficulty in manufacturing process, which may result in roundness-error in parts, and the error can affect the contact area and transmission efficiency between the bearing and the hub body and further increase the probability of damage of the hub body. Therefore, there remains a need for a new and improved design for a bicycle hub apparatus to overcome the problems presented above.

### SUMMARY OF THE INVENTION

The present invention provides a soundless bicycle hub apparatus which comprises a wheel hub, a hub body for installing a sprocket, and a one-way bearing unit positioned between the wheel hub and the hub body. A connecting housing is formed at a lateral end of the wheel hub, and a shaft axially protrudes from a central portion of the connecting housing. A driving ring made of high-strength material is securely positioned in the connecting housing, and a driving surface is formed on an inner periphery of the driving ring. The hub body comprises a gear sleeve and a driving sleeve, and the driving sleeve has a driving section. Two first bearing members respectively coupled with an inner periphery of the driving sleeve are configured to be disposed on the shaft. The bearing unit disposed between the driving surface of the driving ring and the driving section of the driving sleeve comprises an annular cage sleeve, and a plurality of engaging blocks are engaged with the cage sleeve. An elastic unit is disposed on an outer periphery of the cage sleeve to secure the engaging blocks.

In one embodiment, an inner threaded section is formed at an inner periphery of the connecting housing while an outer periphery of the driving ring has an outer threaded section which is configured to engage with the inner threaded section.

In another embodiment, a plurality of locating grooves are axially formed on the inner periphery of the connecting housing while the outer periphery of the driving ring comprises a plurality of locating protrudes which are adapted to respectively engage with the locating grooves.

In still another embodiment, an annular groove formed at an outer end of the connecting housing is cooperated with a C-shaped lock ring to secure a position of the driving ring.

In a further embodiment, the gear sleeve has a connecting opening, and the driving sleeve comprises an engaging section which is configured to engage with the connecting opening of the gear sleeve, and a locating sleeve is positioned between the two first bearing members.

In still a further embodiment, the connecting opening and the engaging section respectively have continuous gear sections to engage with each other.

In yet a further embodiment, a first O-ring is disposed on the driving section to abut against an outer end of the bearing unit which is close to the engaging section; a peripheral groove is formed at an inner end of the driving section, and a second O-ring is disposed in the periphery groove to limit a position of the bearing unit at an inner end thereof.

In a particular embodiment, the cage sleeve has a plurality of through holes, and each of the engaging blocks is configured to obliquely penetrate through and engage with the through hole; each of the engaging blocks has a concave surface, and the elastic unit is configured to push against each of upper ends of the engaging blocks; each of the engaging blocks has an interior end and an exterior end, and based on the rotation direction of a wheel of a bicycle, each of the interior ends is configured to engage or disengage with the driving section of the driving sleeve while each of the exterior ends is adapted to engage or disengage with the driving surface of the driving ring.

In an advantageous embodiment, the wheel hub has a connecting space which has an inner diameter larger than the connecting housing, and a lubricating bearing member is disposed on the driving section of the driving sleeve before the bearing unit is disposed on the driving section, and the lubricating bearing member is adapted to be securely coupled with the connecting space.

Comparing with conventional bicycle hub apparatus, the present invention is advantageous because: (i) the driving ring is installed in the connecting housing of the wheel hub, and the hub body comprises the gear sleeve and the driving sleeve, wherein the driving ring and the driving sleeve are made of high-strength material, which not only makes the bicycle hub apparatus lightweight but also prevents the wheel hub and the hub body from worn by the bearing unit, thereby improving transmission efficiency; (ii) the hub body comprises the gear sleeve and the driving sleeve which can be assembled together after manufactured individually, that simplifies the difficulty in manufacturing process and reduces defects; and (iii) the gear sleeve and the driving sleeve can be changed individually, which provides different combination choices for a bicyclist and further lowers costs when a single part needs to be changed.

### BRIEF DESCRIPTION OF THE DRAWINGS

FIG. 1 is a three-dimensional assembly view of a bicycle hub apparatus in the present invention.

FIG. 2 is a three-dimensional exploded view of the bicycle hub apparatus in the present invention.

FIG. 3 is a three-dimensional exploded view of another embodiment of a connection between a driving ring and a connecting housing of a wheel hub of the bicycle hub apparatus in the present invention.

FIG. 4 is a sectional assembly view of the bicycle hub apparatus in the present invention.

FIG. 5 is a sectional assembly view from another angle of the bicycle hub apparatus in the present invention.

FIG. 6 is a schematic view illustrating a hub body of the bicycle hub apparatus is stopped or rotated in a backward direction in the present invention.

FIG. 7 is a partial enlarged view of FIG. 6.

FIG. 8 is a schematic view illustrating the hub body of the bicycle hub apparatus is rotated in a forward direction in the present invention.

FIG. 9 is a partial enlarged view of FIG. 8.

FIG. 10 is a three-dimensional exploded view of another embodiment of the bicycle hub apparatus in the present invention.

FIG. 11 is a sectional assembly view of another embodiment of the bicycle hub apparatus in the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

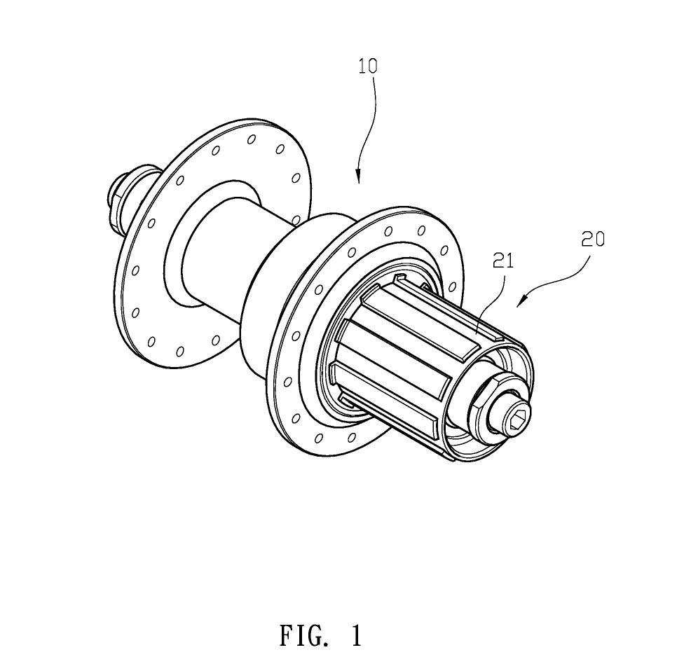

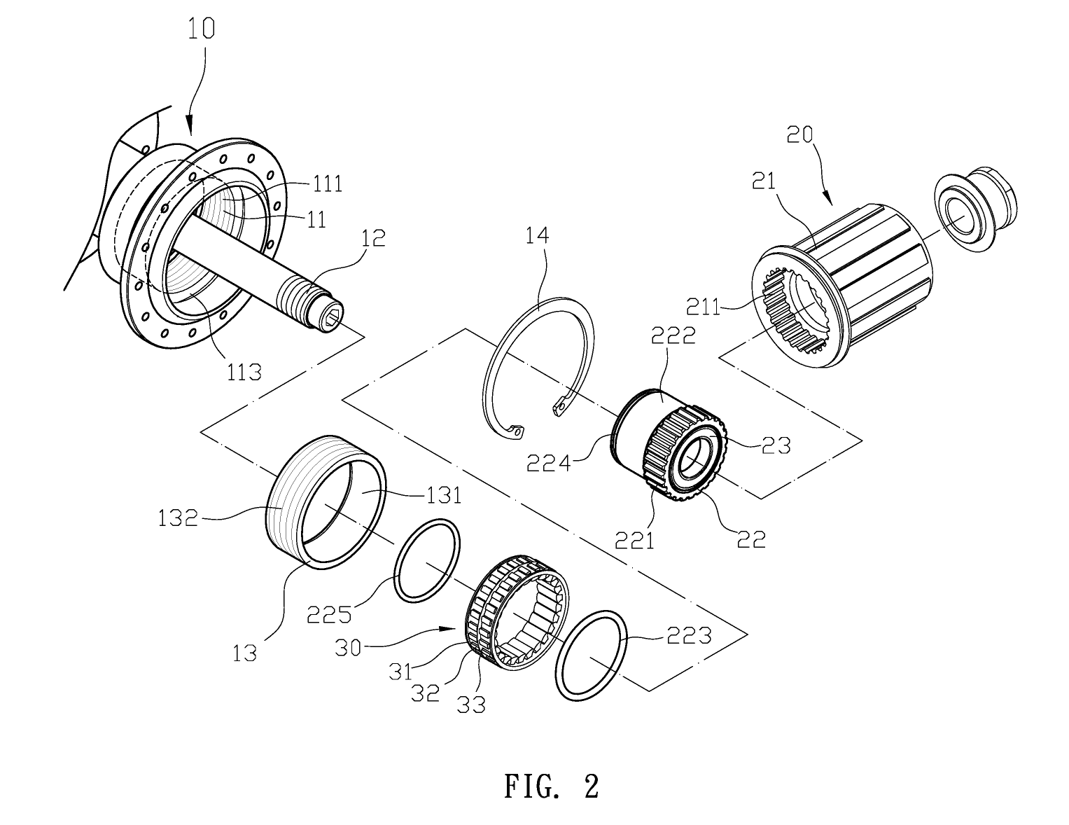

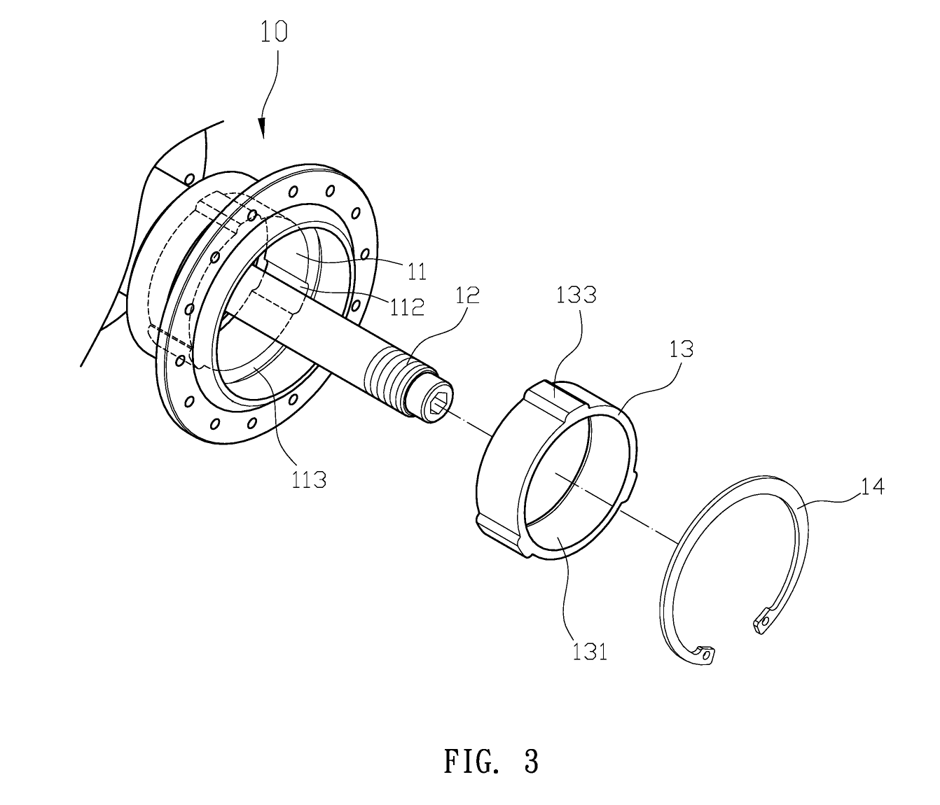

Referring to FIGS. 1 and 2, the present invention provides a soundless bicycle hub apparatus which comprises a wheel hub (10), a hub body (20) for installing a sprocket, and a one-way bearing unit (30). A connecting housing (11) is formed at a lateral end of the wheel hub (10), and a shaft (12) axially protrudes from a central portion of the connecting housing (11). A driving ring (13) made of high-strength material is securely positioned in the connecting housing (11), and a driving surface (131) is formed on an inner periphery of the driving ring (13). The driving ring (13) has at least two methods to connect to the connecting housing (11). In one embodiment, an inner threaded section (111) is formed at an inner periphery of the connecting housing (11) while an outer periphery of the driving ring (13) has an outer threaded section (132) which is configured to engage with the inner threaded section (111). In another embodiment, referring to FIG. 3, a plurality of locating grooves (112) are axially formed on the inner periphery of the connecting housing (11) while the outer periphery of the driving ring (13) comprises a plurality of locating protrudes (133) which are adapted to respectively engage with the locating grooves (112). Moreover, an annular groove (113) formed at an outer end of the connecting housing (11) is cooperated with a C-shaped lock ring (14) to secure the driving ring (13) in the connecting housing (11).

The hub body (20) comprises a gear sleeve (21) and a driving sleeve (22) which are made of different materials. The gear sleeve (21) has a connecting opening (211), and the driving sleeve (22) comprises an engaging section (221) which is configured to engage with the connecting opening (211) of the gear sleeve (21) to enable the driving sleeve (22) and the gear sleeve (21) to have synchronous rotation. In one embodiment, an inner periphery of the connecting opening (211) and an outer periphery of the engaging section (221) respectively have continuous gear sections which are adapted to engage with each other. Furthermore, the driving sleeve (22) has a driving section (222) which is integrally formed with the engaging section (221), and two first bearing members (23) are respectively coupled with an inner periphery of the driving sleeve (22) while a locating sleeve (231) is positioned between the two first bearing members (23) to limit positions of the two first bearing members (23).

The bearing unit (30) disposed between the driving surface (131) of the driving ring (13) and the driving section (222) of the driving sleeve (22) comprises an annular cage sleeve (31), and a plurality of engaging blocks (32) are engaged with the cage sleeve (31). Also, an elastic unit (33) is disposed on an outer periphery of the cage sleeve (31) to secure the engaging blocks (32). More specifically, the cage sleeve (31) has a plurality of through holes, and each of the engaging blocks (32) is configured to obliquely penetrate through and engage with the through hole. Furthermore, each of the engaging blocks (32) has a concave surface, and each of upper ends of the engaging blocks (32) is abutted by the elastic unit (33), wherein the elastic unit (33) is configured to keep each of the engaging blocks (32) at an initial tilted position and to move the engaging block (32) back to the initial tilted position when the engaging block (32) is released from external force.

Structurally, referring to FIGS. 1,2 and 4 to 7, the wheel hub (10) has the connecting housing (11), and the driving ring (13) made of high-strength material is installed therein. The gear sleeve (21) and the driving sleeve (22) are connected to have synchronous rotations, and the bearing unit (30) is disposed on the driving section (222) of the driving sleeve (22). Each of the engaging blocks (32) has an interior end (321) and an exterior end (322). Moreover, each of the interior ends (321) of the engaging blocks (32) coupled with the driving section (222) is configured to engage with the driving section (222) to have synchronous rotations when rotated in a backward direction, and configured to disengage with the driving section (222) to rotate independently when rotated in a forward direction. Moreover, a first O-ring (223) is disposed on the driving section (222) to abut against an outer end of the bearing unit (30) which is close to the engaging section (221), and a peripheral groove (224) is formed at an inner end of the driving section (222). In addition, a second O-ring (225) is disposed in the periphery groove (224) to couple with an inner end of the bearing unit (30). The first O-ring (223) and the second O-ring (225) are configured to limit a position of the bearing unit (30) therebetween, and the hub body (20) together with the bearing unit (30) is adapted to be connected to the wheel hub (10). The bearing unit (30) is configured to be coupled with the inner periphery of the driving ring (13), and the hub body (20) is disposed on the shaft (12) to enable two inner peripheries of the two first bearing members (23) to couple with the shaft (12).

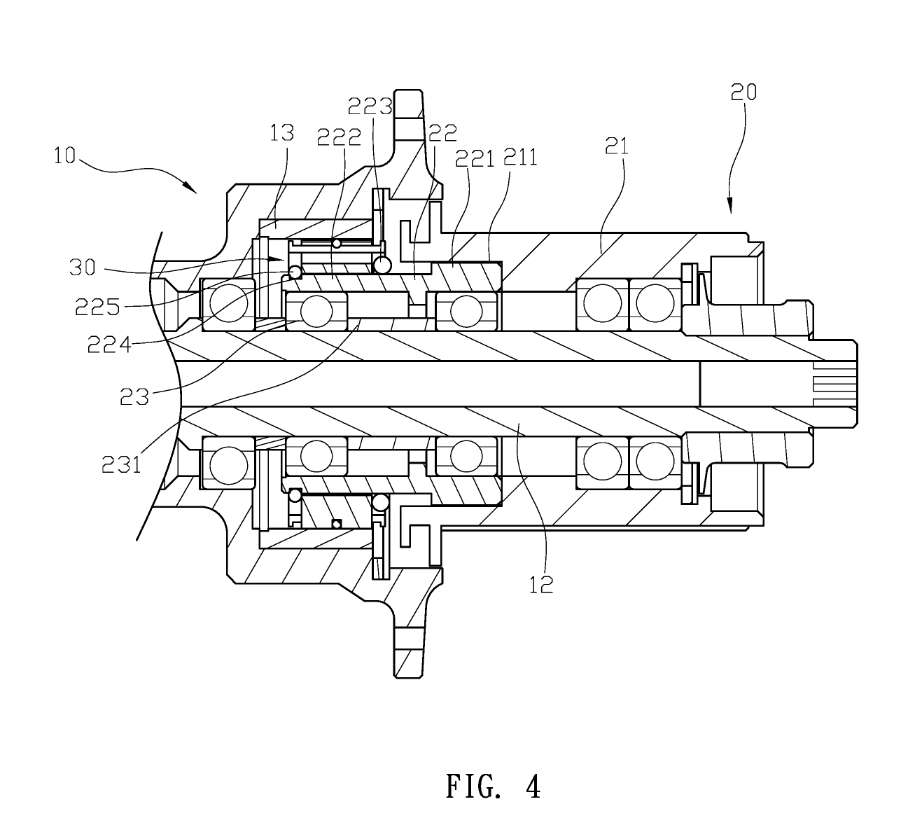

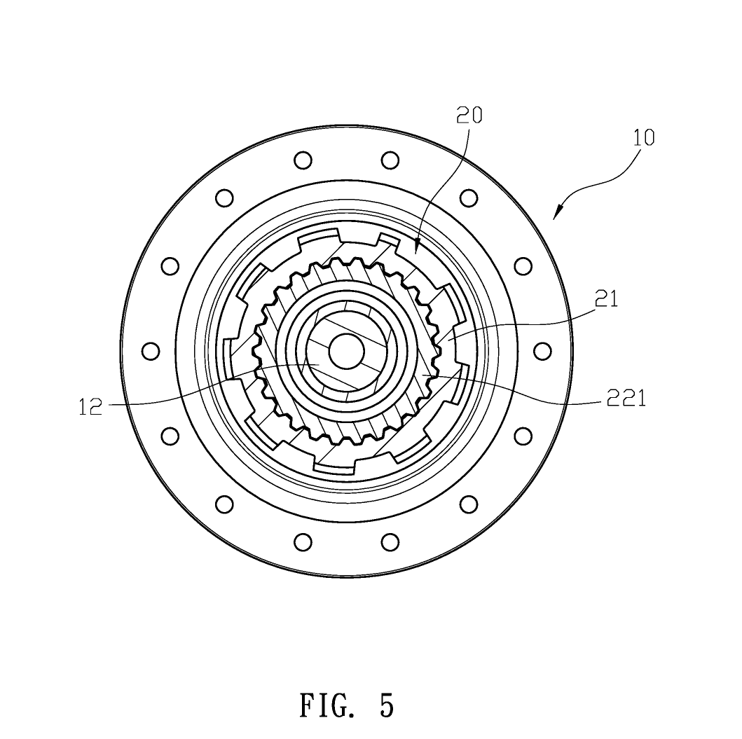

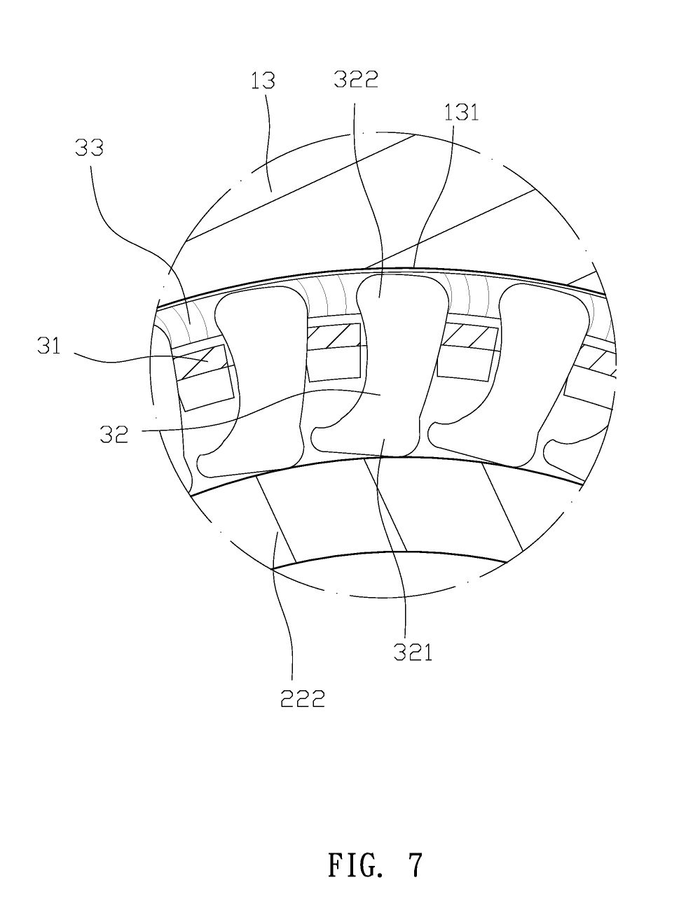

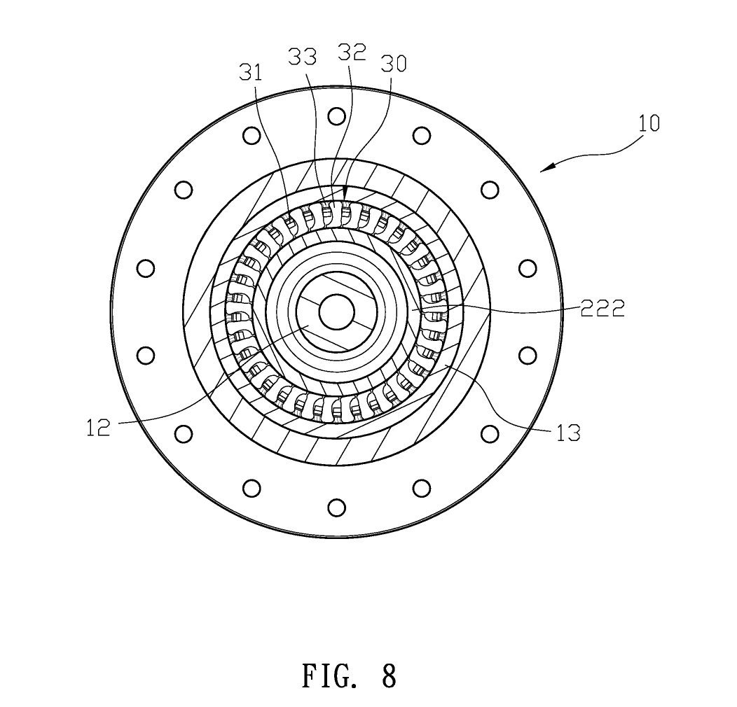

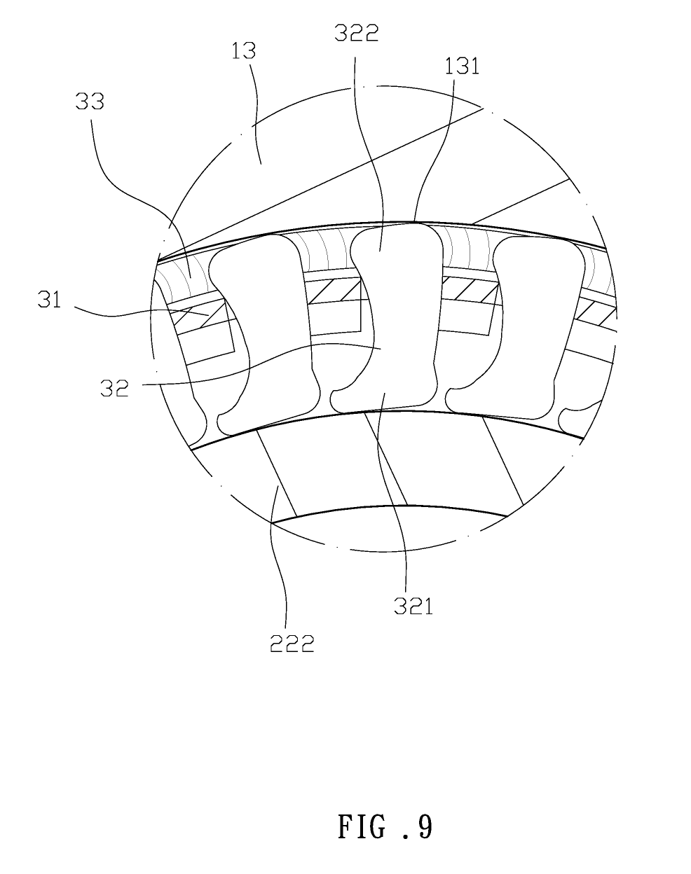

In actual application, referring to FIGS. 4, 5, 8 and 9, when a bicyclist pedaling forward, the hub body (20) is driven to rotate in a forward direction, and since a tilted direction of the engaging blocks (32) of the bearing unit (30) is opposite to a rotation direction of the driving sleeve (22) of the hub body (20) (as shown in FIG. 7), the driving section (222) of the driving sleeve (22) is configured to engage with and drive the interior ends (321) of the engaging blocks (32) to move forward. Thus, each of the engaging blocks (32) is adapted to have seesaw movement to enable the exterior end (322) thereof to move backward to bear against the driving surface (131) of the driving ring (13), and through the bearing unit (30), the wheel hub (10) is configured to have synchronous rotation together with the hub body (20), thereby driving a wheel to move forward.

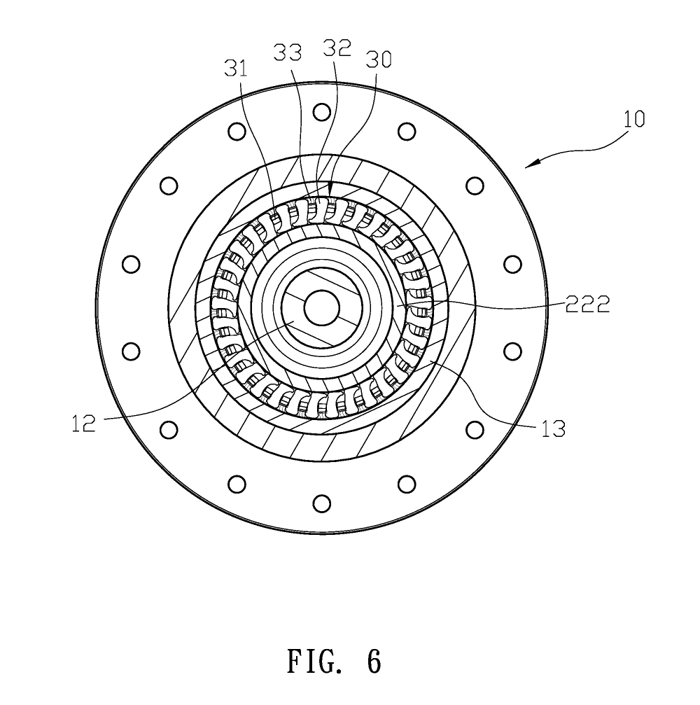

On the contrary, in case that the bicyclist stops pedaling or pedaling backward when the bicycle is moving forward, the hub body (20) is not driven or is rotated backward. In this time, referring to FIGS. 6 and 7, the tilted direction of the engaging blocks (32) of the bearing unit (30) is the same as the rotation direction of the driving sleeve (22) of the hub body (20), and the driving section (222) of the driving sleeve (22) is adapted to disengage from the interior ends (321) of the engaging blocks (32) and rotate independently. Meanwhile, each of the engaging blocks (32) is configured to be compressed by the elastic unit (33) to move back to the initial tilted position, and each of the exterior ends (322) of the bearing blocks (32) is configured to detach from the driving surface (131) of the driving ring (13). Thus, the hub body (20) and the wheel hub (10) are configured to have rotations independently, thereby enabling the bike to keep coasting.

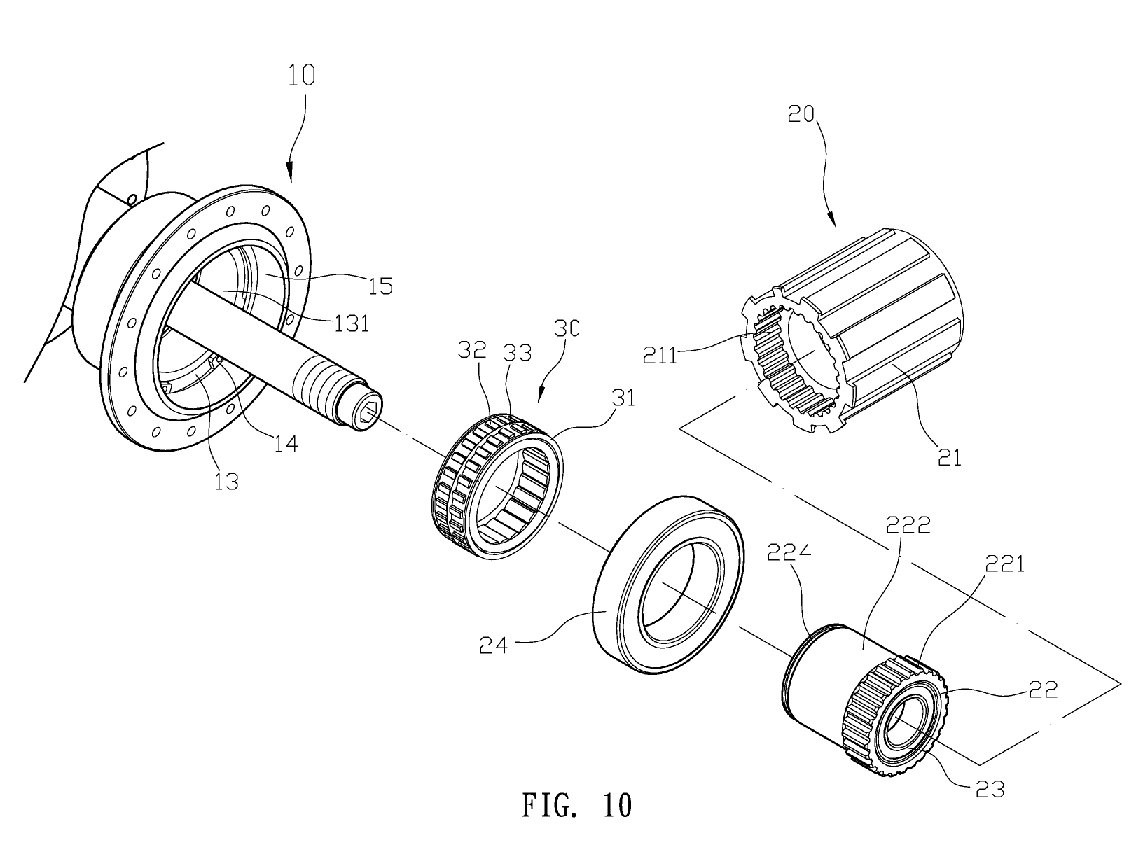

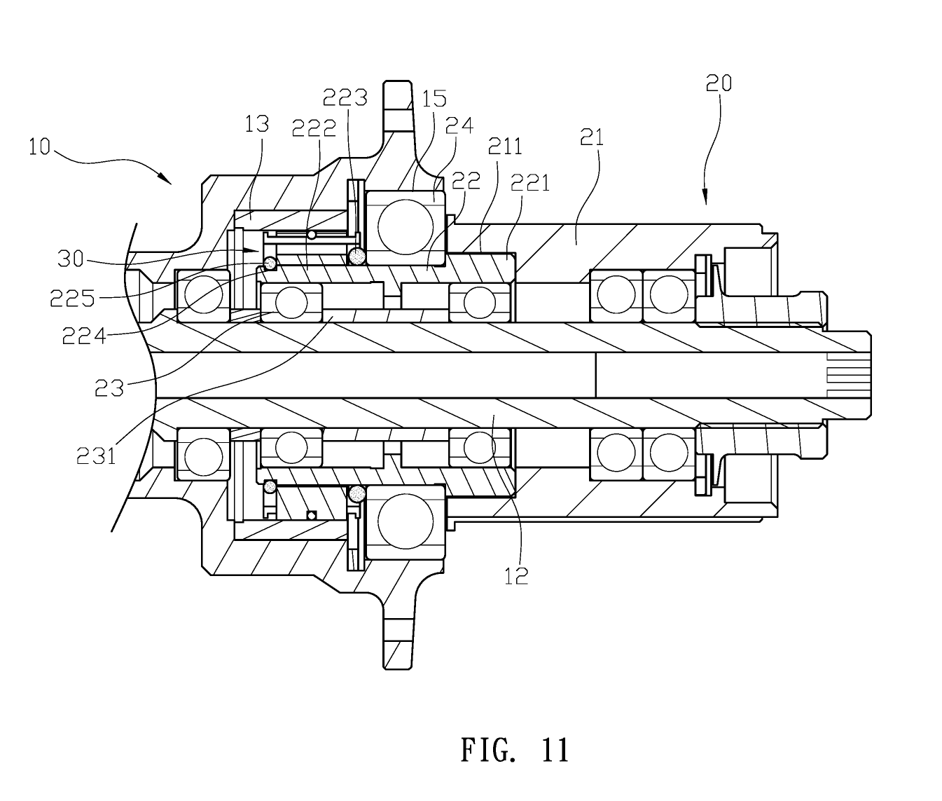

In another embodiment, referring to FIGS. 10 and 11, the lateral end of the wheel hub (10) has a connecting space (15) which has an inner diameter larger than the connecting housing (11), and a lubricating bearing member (24) is disposed on the driving section (222) of the driving sleeve (22) to bear against the engaging section (221) before the bearing unit (30) is disposed on the driving section (222). Thus, when the hub body (20) together with the bearing unit (30) is connected to the wheel hub (10), the lubricating bearing member (24) is securely coupled with the connecting space (15) to enable the driving sleeve (22) to rotate more smoothly when individually rotating in the wheel hub (10).

Comparing with conventional bicycle hub apparatus, the present invention is advantageous because: (i) the driving ring (13) is installed in the connecting housing (11) of the wheel hub (10), and the hub body (20) comprises the gear sleeve (21) and the driving sleeve (22), wherein the driving ring (13) and the driving sleeve (22) are made of high-strength material, which not only makes the bicycle hub apparatus lightweight but also prevents the wheel hub (10) and the hub body (20) from worn by the bearing unit (30), thereby improving transmission efficiency; (ii) the hub body (20) comprises the gear sleeve (21) and the driving sleeve (22) which can be assembled together after manufactured individually, that simplifies the difficulty in manufacturing process and reduces defects; and (iii) the gear sleeve (21) and the driving sleeve (22) can be changed individually, which provides different combination choices for a bicyclist and further lowers costs when a single part needs to be changed.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A soundless bicycle hub apparatus comprising a wheel hub, a hub body for installing a sprocket, and a one-way bearing unit positioned between the wheel hub and the hub body; a connecting housing formed at a lateral end of the wheel hub, and a shaft axially protruding from a central portion of the connecting housing; a driving ring, which is made of high-strength material, securely positioned in the connecting housing, and a driving surface formed on an inner periphery of the driving ring; the hub body comprising a gear sleeve and a driving sleeve, and the driving sleeve having a driving section; two first bearing members, which are respectively coupled with an inner periphery of the driving sleeve, configured to be disposed on the shaft; the bearing unit, which is disposed between the driving surface of the driving ring and the driving section of the driving sleeve comprising an annular cage sleeve, and a plurality of engaging blocks engaged with the cage sleeve; and an elastic unit configured to be disposed on an outer periphery of the cage sleeve to limit positions of the engaging blocks.

2. The bicycle hub apparatus of claim 1, wherein an inner threaded section is formed at an inner periphery of the connecting housing while an outer periphery of the driving ring has an outer threaded section which is configured to engage with the inner threaded section.

3. The bicycle hub apparatus of claim 1, wherein a plurality of locating grooves are axially formed on the inner periphery of the connecting housing while the outer periphery of the driving ring comprises a plurality of locating protrudes which are adapted to respectively engage with the locating grooves.

4. The bicycle hub apparatus of claim 1, wherein an annular groove formed at an outer end of the connecting housing is cooperated with a C-shaped lock ring to secure a position of the driving ring.

5. The bicycle hub apparatus of claim 1, wherein the gear sleeve has a connecting opening, and the driving sleeve comprises an engaging section which is configured to engage with the connecting opening of the gear sleeve, and a locating sleeve is positioned between the two first bearing members.

6. The bicycle hub apparatus of claim 5, wherein the connecting opening and the engaging section respectively have continuous gear sections to engage with each other.

7. The bicycle hub apparatus of claim 1, wherein a first O-ring is disposed on the driving section to abut against an outer end of the bearing unit which is close to the engaging section; a peripheral groove is formed at an inner end of the driving section, and a second O-ring is disposed in the periphery groove to limit a position of the bearing unit at an inner end thereof.

8. The bicycle hub apparatus of claim 7, wherein the driving section and the engaging section are formed integrally.

9. The bicycle hub apparatus of claim 1, wherein the cage sleeve has a plurality of through holes, and each of the engaging blocks is configured to obliquely penetrate through and engage with the through hole; each of the engaging blocks has a concave surface, and the elastic unit is configured to push against each of upper ends of the engaging blocks; each of the engaging blocks has an interior end and an exterior end, and based on the rotation direction of a wheel of a bicycle, each of the interior ends is configured to engage or disengage with the driving section of the driving sleeve while each of the exterior ends is adapted to engage or disengage with the driving surface of the driving ring.

10. The bicycle hub apparatus of claim 1, wherein the wheel hub has a connecting space which has an inner diameter larger than the connecting housing, and a lubricating bearing member is disposed on the driving section of the driving sleeve before the bearing unit is disposed on the driving section, and the lubricating bearing member is adapted to be securely coupled with the connecting space.
